(19) United States
(12) Patent Application Publication
(10) Pub. No.: US 2008/0126135 A1
(43) Pub. Date: May 29, 2008

(54) Paperless medication prescription system

(76) Inventor: Edward T. Woo, Sumner, MS (US)

Correspondence Address: THE MATTHEWS FIRM, 2000 BERING DRIVE, SUITE 700, HOUSTON, TX, 77057, US

(21) Appl. No.: 11/973,082

(22) Filed: Oct. 5, 2007

Related U.S. Application Data
(60) Provisional application No. 60/861,376, filed on Nov. 28, 2006.

(51) Int. Cl. G06Q 50/00

(52) U.S. Cl. 705/3

(57) ABSTRACT

A paperless medication prescription is provided which allows prescriptions to be transferred electronically between a doctor's office and a pharmacy. The system involves the use of a secure smart card or other patient controlled memory medium in conjunction with a networked system of computers. Redundant information is stored on the patient's smart card and on the network reducing the chance of patient abuse and decreasing the chance of system malfunction due to network problems or the loss of the smart card.

### RELATED APPLICATIONS

This application claims priority from Provisional Patent Application No. 60/861,376 filed Nov. 28, 2006 entitled Paperless Medication Prescription System.

### BACKGROUND OF THE INVENTION

1. Field of the Invention

This invention relates generally to an electronic communication network which improves the accuracy and efficiency of medication dispensation, maintains secure patient medical data, and is capable of operating despite communication failures caused by technical problems or natural disasters.

2. Background

When a patient requires medical attention, he must enter into a process involving two groups. The first group comprises doctors who prescribe medications for the purpose of treatment. The second 2 group comprises pharmacists who dispense the appropriate medication. Because society does not allow patients to have free access to all of the drugs on the market, doctors must transmit instructions, also known as prescriptions, to the pharmacists granting a patient access to potent drugs in a manner that is both understandable and secure.

This process can be complicated by the fact that patients often see multiple doctors. Typically, each doctor maintains a separate record of a patient's medical history either in an electronic or paper medium. Because of the nature of this system, doctors must give prescriptions without accurate knowledge of what other medications a patient is on or has been given. Typically, the patient would be asked to provide information about their medications. However, accidental and even intentional omissions or inaccuracies leave a degree of uncertainty for the doctor. This system of blind prescribing increases the risk that a patient will suffer from a drug interaction. Also, a patient may take advantage of the current system by obtaining prescriptions from multiple doctors and resell them illegally.

Most pharmacies keep their own records relating to what medications a patient has previously obtained. This reduces the risk that a patient will obtain large amounts of medication from one pharmacy for illegal purposes. However, a patient may visit multiple pharmacies. There is currently no system to consolidate the medical records at various pharmacies and doctors' offices to prevent the improper dispensation of medication, whether caused by accidental or intentional patient omission.

Another problem arises because most doctors transmit prescriptions through a hand-written or type-written medium. The pharmacist must then interpret the prescription given by a person who they may never interact with directly. This poses potential dangers to the patient, because a pharmacist may misinterpret a badly written prescription and dispense medications that may have dangerous effects on the patient. Typewritten notes significantly reduce this risk. However, both hand written and typewritten notes also take time to manually input into the pharmacy's computer system, which increases the patients' wait time and decreases the pharmacy's efficiency. With type written or hand written prescriptions, mistakes can occur interpreting the prescription or entering the prescription into a computer.

There are various other problems with the current prescription system. Written notes are susceptible to forgeries and other forms of patient abuse. Also, under the current system, if a patient wishes to move an ongoing prescription to a different pharmacy, the new pharmacist must contact either the doctor or the previous pharmacy to ensure the patient is entitled to the medication in question. This further decreases the efficiency of the system. Additionally, if a patient loses a prescription, he must return to the doctor and potentially restart the diagnosis process from the beginning.

Various methods of electronically transferring prescription data exist, but each has associated problems. The method of transferring prescription data to a smart card helps prevent some of the aforementioned problems. However, if a patient loses his smart card while away from their local doctor's office, as often happens in cases of emergency, that patient must operate without his medication until another doctor may see him and restart the diagnosis process. Systems that are based solely on networked electronic transfer are also undesirable due to problems with patient identification and an inability to function if the network is disconnected due to system malfunction.

Therefore, what is needed is a paperless medication prescription system that does not suffer from the aforementioned problems. This medication system should be resistant to tampering and patient abuse. This system should also be capable of operating if the patient loses his prescription card and be capable of ensuring that the person requesting services at the pharmacy is the correct patient. Additionally, the system should decrease the possibility of misinterpretation associated with handwritten instructions and increase efficiency. Furthermore, other desirable features and characteristics of the present invention will become apparent when this background of the invention is read in conjunction with the subsequent detailed description of the invention, appended claims, and the accompanying drawings.

### SUMMARY OF THE INVENTION

The present invention advantageously fills the aforementioned deficiencies by providing a paperless medication prescription system that is resistant to tampering and patient abuse, operates even if the patient loses his prescription card, helps pharmacists and doctors correctly identify patients, and decreases the possibility of human error. The present invention accomplishes this by providing both a networked system of local databases contained on memory storage devices connected to a central database and secure prescription card for patient use and identification.

Paperless Medication Prescription System

In one particular embodiment of the present invention, a patient is issued a card containing a memory unit. An appropriate issuing entity such as a doctor's office, pharmacy, insurance company, hospital, or other medical or government agency may load the patient's medical history and security data to the memory unit of the card using established card reading/writing technology once the patient has been satisfactorily identified. After loading patient data onto the memory unit of the card, the patient's medical history is also loaded to a central database connected to the issuer's doctor and/or pharmacist component. The patient may then visit his doctor for an ailment, and swipe, scan or RFID his card in the doctor's card reader and present his security data. The doctor may view the patient's medical history or other relevant information and load a prescription to the card. When data is transferred or updated on the patient's card, the system will automatically update the patient's medical history and prescription or prescription history on the central database. The patient may then interface the card with the pharmacy's reader, and present his security data. This interface could be accomplished though smart card technology, card readers, RFID, flash drives, memory cards, memory sticks or even over the internet from a remote location. Upon verification, the pharmacist may fill the patient's prescription and update the patient's card and the central database with data indicating the prescription has been filled. The pharmacy and doctor's office may or may not be equipped with local databases contained on memory storage devices, which keep separate records of the patient's medical history.

In another embodiment of the present invention, a patient loses his card after receiving a prescription but before getting the prescription filled at a pharmacy. The patient proceeds to an appropriate issuing entity and requests another card. Upon verification of the patient's identity, the issuing entity sends a request to the central database for the patient's medical history, security data, and prescription data. The issuing entity then loads the patient's medical history and prescription data to his card and uploads data to the central database indicating that the previous card is no longer valid. The patient may then take his card to a pharmacy, interface the card in the pharmacy's card reader, and present his security data. Upon verification, the prescription is transferred from the patient's new card to the pharmacist's computer. The pharmacist may fill the patient's prescription and update the patient's card and the central database with data indicating the prescription has been filled.

In still another embodiment of the present invention, an unauthorized user finds a lost prescription card. The unauthorized user takes the card to the pharmacist to have any prescription filled. When the unauthorized user attempts to use the card at the pharmacy, the unauthorized user will be unable to present the appropriate security data. The pharmacist will refuse to fill the prescription due to lack of identity verification. If another card has been issued the central database may inform the pharmacist component that the card has been deactivated. If the patient has already been issued a new card, the pharmacist will know that the person is not the patient but is an unauthorized user attempting to steal the patient's identity and may take appropriate action. There may arise situations where it is desirable to have another authorized user. For example, a family member or guardian may be responsible for picking up medications on behalf of a disabled individual. In the present invention, an authorized user can be added by adding additional security data to the memory of the patient component, such as a second pin or password for the second authorized user.

The present invention now will be described more fully hereinafter with reference to the accompanying drawings, which are intended to be read in conjunction with both this summary, the detailed description and any preferred and/or particular embodiments specifically discussed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The drawings contained herein exemplify a preferred embodiment of the claimed invention. It should be noted that the invention is not limited to the embodiment shown. The embodiment shown is purely an example, and the invention is capable of variations of said embodiment. In the drawings:

FIG. 1 is a functional system diagram of a paperless medication prescription system according to the present invention.

FIG. 2 is a logic flow diagram showing how the present invention could be used to fill a prescription.

FIG. 3 is an illustration of a processor which can be used as the doctor component or the pharmacist component.

### DETAILED DESCRIPTION OF THE INVENTION

The present invention is directed to a paperless medication prescription system.

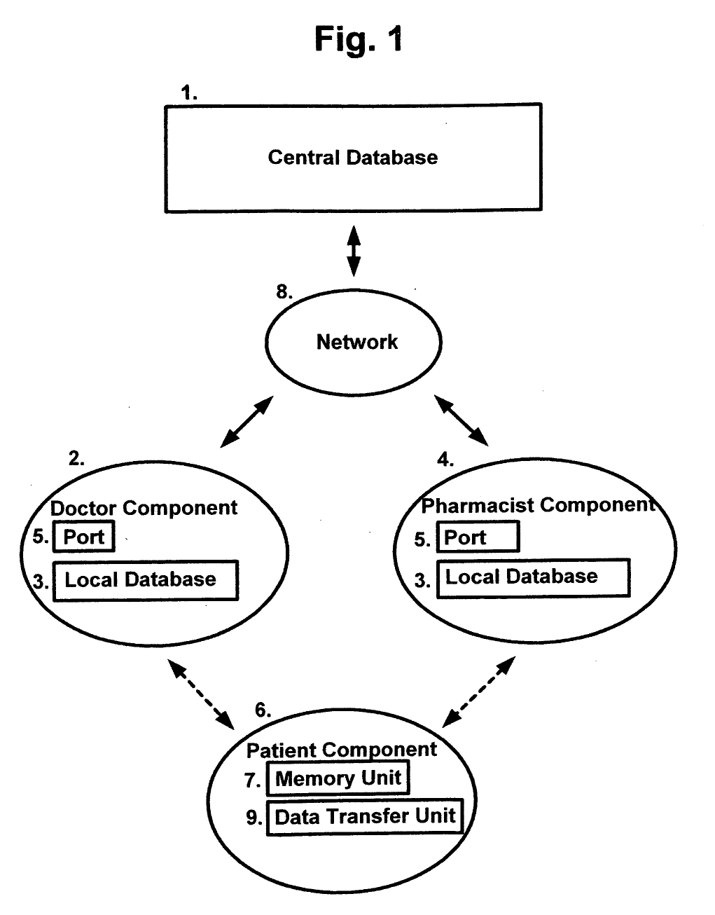

FIG. 1 illustrates a diagram of an embodiment of the present invention comprising a central database 1 connected to at least one doctor component 2 and at least one pharmacist component 4 through a network 8. The patient component 6 is a medium for storing individual patient's medical history including prescriptions. In operation the doctor component 2 interfaces the patient component 6 in order to write a prescription in the form or prescription data onto the patient component 6. The pharmacist component 4 interfaces with the patient component 6 to read the prescription data stored thereon. A patient's prescription can be filled using this data then pharmacist component 4 updates the prescription data stored on the patient component 6 indicating the prescription has been filled. The central database 1 serves as a back up or redundant source of data. The central database can be updated by either the doctor component 2 or the pharmacist component 4 during their interaction with the patient component 6 or shortly thereafter through the network 8.

In one embodiment, there are a plurality of doctor components 2, which may be located at different of doctors' offices or hospitals, a plurality of pharmacist components 4 which may be located at different pharmacies, and a plurality of patient components 6 which are kept by a plurality of patients. In this way the paperless prescription system allows patients to visit different doctors and have their prescriptions filled by different pharmacies accurately and efficiently.

The central database 1 is a computer or other electronic device capable of receiving, storing, retrieving, analyzing, and transmitting a patient's medical history. The central database 1 performs these tasks by using a memory storage device, a processing unit for manipulating data, and a communication unit such as a modem, network card, or any other device that may be used to send and receive information over an electronic network. In one embodiment, the central database 1 is a single computer or server comprising a processor, a hard drive, and a network communications device. However, a small group of interconnected computers or a large network of interconnected computers may be substituted to perform the task of the central database. A patient's medical history is any information about the patient's background, treatment history, or other information pertinent to patient treatment including prescription data, which is the data necessary to make and fill a prescription. The central database 1 is connected to at least one doctor component 2 and at least one pharmacist component 4 through the network 8.

The network 8 is a system of computers or other electronic devices connected in an internet, intranet, LAN, WAN, or other configuration that allows multiple electronic systems to exchange information.

The doctor component 2 is an electronic device capable of reading and writing or transmitting a patient's medical history and prescription data to and from a patient component 6. The doctor component 2 must also be capable of sending and receiving a patient's medical history and prescription data to and from the central database 1 through the network 8. The doctor component 2 may also store some or all of the patient's medical history, including prescription data, sent or received from the central database 1 or the patient component 6 onto a local database 3. Additionally, the doctor component 2 may analyze a patient's medical history in order to indicate possible drug interactions or to warn of situations in which the patient has or is about to obtain an unreasonable amount of controlled medications.

The pharmacist component 4 also may be any electronic device that could be used as a doctor component 2, so long as the component is capable of reading a prescription or other information from the memory unit 7 of the patient component 6 as well as writing prescription data to the patient component. The pharmacist component would update the prescription data, for example, indicating a prescription is filled. The pharmacist component 4 may also store some or all of the patient's medical history, including prescription data, sent or received from the central database 1 or the patient component 6 onto a local database 3. The doctor component 2 and the pharmacist component 4 may, but need not be, the same type of device or a similar type of device. In one embodiment both the doctor component and the pharmacist component may be processors such as typical computers.

Each patient component 6 is equipped with a memory unit 7 capable of storing and retrieving some or all of a patient's medical history, and a data transfer unit 9 capable of sending and receiving some or all of a patient's medical history. Patient components 6 such as portable memory mediums including smart cards, RFID, memory cards and memory sticks are considered to contain both memory unit 7 and data transfer unit 9. A smart card, sometimes referred to as a chip card, contains a computer chip embedded in the plastic about the size of a credit card. Whereas a typical credit card's magnetic stripe can hold only a few dozen characters, smart cards are only limited by the embedded computer chip. When read by readers, the cards can perform a number of functions or access data stored in the chip. Smart cards can be used as ID cards with stored-in passwords or pin numbers.

Each of the doctor components 2 and pharmacist components 4 is equipped with a port 5 that can interface with the data transfer unit 9 of a patient component 6. A port 5 is any device that can pass information from the local database 3 of the pharmacist component 4 or doctor component 2 to the data transfer unit 9 of the patient component 6. Examples of ports 5 include a smart card reader, a memory card reader, a USB port, a serial port, a parallel port, an Ethernet port, an RFID, an infrared port, a modem, a router, a wireless router, or any other device that can perform a similar function. A data transfer unit 9 is any device that can pass information from the memory unit 7 of a patient component 6 to the port 5 of a doctor component 2 or pharmacist component 4. Examples of a data transfer units 9 include a smart card, a memory card, a memory stick, a flash drive, magnetic strip, a USB connector, a serial port, a parallel port, an Ethernet port, an RFID, an infrared port, a modem, a wireless card, or any other device that can perform a similar function. The only requirement is that the data transfer unit 9 must be of a corresponding technology with the port 5 to properly connect and transfer data. The port 5 and the data transfer unit 9 may or may not be the same type of device, depending on the technology used, and may require an intermediate connector such as a cable. An example of when the port 5 and the data transfer unit 9 are different is the magnetic strip and smart card reader embodiment. Interface means to connect in such a way as to allow data to be transferred from the memory unit 7 or database 3 of one component to the memory unit 7 or database 3 of another component. Using said interface, any doctor component 2 or pharmacist component 4 could send and receive data from its local database 3 to and from the memory unit 7 of the patient component 6.

In one embodiment, each component should be capable of storing some or all of the patient's medical history in the appropriate database or memory. In an alternate embodiment, the doctor component 2 and/or pharmacist component 4 may or may not retain the patient's medical history. The patient's medical history may include several items that would be of use to medical professionals. The patient's medical history is constrained only by the amount of data that may be stored on the appropriate memory devices and databases. The following items may be included in an individual patient's medical history: prescribing doctor's electronic signature, patient's name, patient's birth date, patient's address, current prescriptions, status of the current prescription (i.e. filled or unfilled) previous prescriptions, specific drug names, directions for drug use, patient's insurance information, patient's picture, list of any diseases associated with the patient, patient's allergies, patient's social security number or other identifications, number of refills on prescriptions, number of refills used, number of tablets per fill, prescriptions generic name, prescriptions strength, manufacturer of prescribed drugs, the original date of any prescriptions, the date any prescriptions were filled, any expiration dates concerning the prescriptions or the patient component itself, identifying information of the pharmacies that filled previous prescriptions, the method of payment for previous prescriptions and doctor visits, any authorization for persons other than the patient to pick up the prescription, and the name of the person who picked up the associated prescription. The preceding list is meant to be illustrative only and should not be construed as an exhaustive list of the data that may be stored in the patient's medical history. Prescription data is considered to be a subset of data included in the patients' medical history that contains all data necessary make and fill prescriptions. Also, the patient's medical history may be tailored to the needs of the administrators and users of the system. Therefore, many of the items in the preceding list may be eliminated depending on the needs of the entities administrating the system.

It should be noted that the preceding combination of devices is a preferred embodiment. Despite the fact that the invention works best in the abovementioned configuration, other devices may be substituted which perform the same or similar functions.

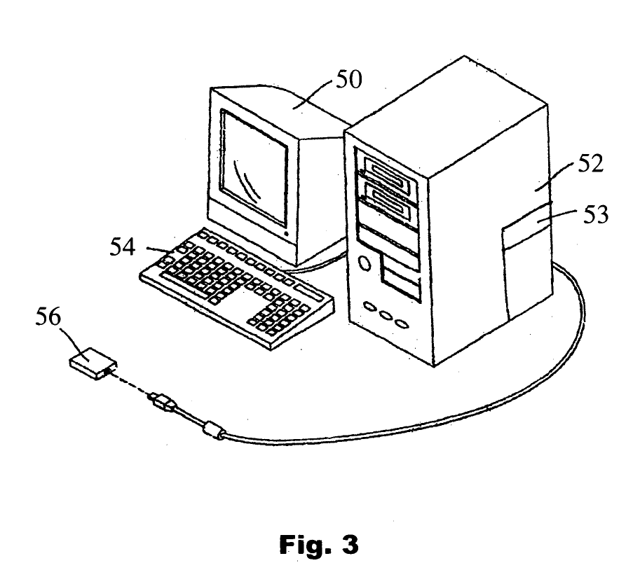

FIG. 3 illustrates an embodiment of the present invention where the doctor component 2 is a typical computer system connected to an associated port 5. The computing system comprises a display such as a computer monitor 50, a processing unit 52 for data storage, retrieval, and manipulation, and an input device such as an alpha numeric keyboard 54. The port 5 is illustrated as a reader 56 capable of reading and writing data to the patient component 6, as previously described. The reader 56 could be a smart card reader, an RFID reader, USB port for interfacing a flash drive or a card reader for reading various memory cards or memory sticks. Additionally, the processing unit 52 contains a communications unit 58 capable of sending and receiving data through the network 8 to the central database 1 such as a modem, network card, or any other device that may be used to send and receive information over an electronic network. FIG. 3 illustrates a desktop as the doctor component 2 or the pharmacist component 4. However, all that is required is a data processor capable of reading, writing and storing data. For example, the processor could be a laptop or even a PDA so long as the processor can be configured to read and write data from the patient component 6 through a port 5 such as a reader 56.

In one embodiment, the pharmacist component 4 is also a computer system with an associated port 5. Again, the reader 56 is an example of the port 5 as previously described. Reader 56 could be a smart card reader, a reader for reading RFID, a USB port for interfacing a flash drive, or an internal card reader for reading various memory cards or memory sticks. Each of the doctor components 2 and pharmacist components 4 is also equipped with a memory storage device 52 containing a local database 3 capable of performing the appropriate storing, retrieving, sorting, searching, and analyzing functions for the associated doctor component 2 or pharmacist component 4. Each also contains a communications unit 58 capable of sending and receiving data through the network 8 to the central database 1. The communications unit 58 can be a modem, network card, or any other device that may be used to send and receive information over an electronic network. While computer systems as discussed above are one embodiment of the pharmacist component 4 and doctor component 2, a person of ordinary skill in the art will recognize that any device may be substituted so long as the device performs the necessary functions.

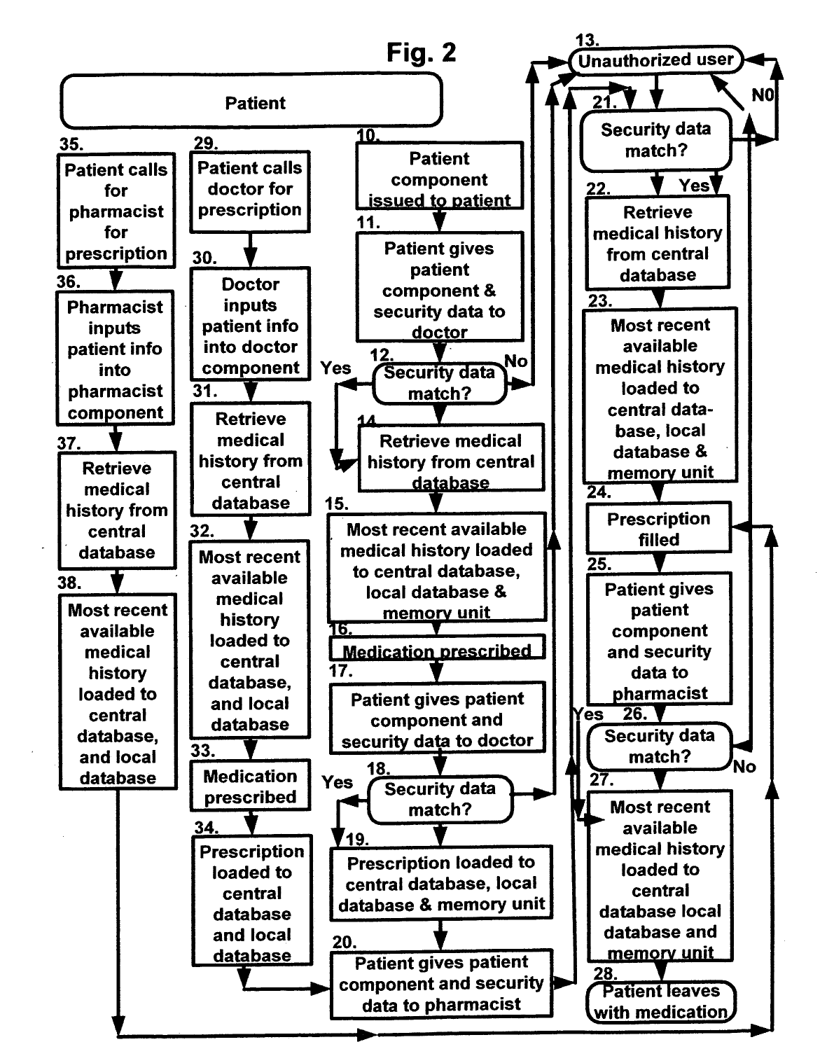

Referring now to FIG. 2 specifically, but also to FIGS. 1 and 3 to establish context, these illustrates a logic flow diagram showing how the present invention as shown in FIG. 1 can be used to fill a prescription. The standard case occurs when a patient needs to see a doctor but is not entered into the system. The patient must first receive a patient component 6 from an issuing entity at 10. The issuing entity may be any agency involved in administering the system including but not limited to a doctor's office, pharmacy, insurance company, hospital, or other medical or government agency. In one embodiment, the patient component 6 is a smart card.

In the one embodiment, the patient component is initialized by loading both the patient's medical history and some security information. The issuing entity compiles the patient's medical history from information presented by the patient and information already on file with the issuing entity, which may be stored on a doctor component 2 or a pharmacist component 4. The issuing entity's doctor component 2 or pharmacist component 4 can interface with the patient component 6 through its port 5 in order to load security data and the initial medical history. This is accomplished through the data transfer unit 9 of the patient component 6, which loads the data to the memory unit 7 of the patient component 6. The patient component 6 is then given to the patient. The patient's medical history may be subsequently modified by the use of an interface each time the patient visits a doctor, is prescribed or fills a prescription for medication, requests and is issued a new patient component, or takes any action that the administrator of the systems deems to be pertinent to the patient's treatment or the administration of the system. The security data are treated hereinafter as a pin number; however, the system may be adapted to accommodate multiple types of security data including but not limited to retinal scans, fingerprints, passwords, RFID technologies, or security questions. All data on the patient component is encrypted by an appropriate encryption method to prevent access by unauthorized personnel. In another embodiment, different levels of access to a patient's medical history may be granted to different individuals and healthcare professionals. In yet another embodiment, security data is not stored on the patient component, and the pharmacists and doctors involved use whatever security they deem appropriate. For example, they could require a photo ID. If the security data is omitted, each time the security data would be required, the system would react as if the security data given was accurate.

After receiving the patient component 6, the patient proceeds to the doctor. The patient presents the patient component 6 and gives the security data to the doctor at 11. At this point, either the patient or personnel at the doctor's office interfaces the patient component 6 and the doctor component 2. The security data are also entered into the doctor component 2. At 12, the processing unit of the doctor component 2 compares the security data entered to the security data stored in the memory unit 7 of the patient component 6. If the security data do not match during this or any other security data comparison, the user is classified as an unauthorized user and denied access at 13. In one embodiment, an emergency override exists so that medical personnel may access the patient's medical history and prescribe the patient medication while a patient is unable to enter security information. In these emergency situations a patient may be unconscious or too ill to enter security data. For instance, in an emergency room doctors may be able to quickly and accurately determine a patient's medical history and/or current prescriptions from the patient component 6. This allows a new hospital to quickly and easily retrieve valuable information without requiring any internet or network connection. One override possibility is the override code and which acts like a pin allowing the doctor to access the patient's card 6 in the same manner as if the security information had been correctly presented. This override code must be entered at the doctor component 2, and can be made secure by a number known techniques. For instance, the override code may change after certain periods of time and must remain generally unknown to the patient.

Otherwise, the patient must then either recall the security data or have the patient component reissued from the issuing entity. If the security data match, the doctor component 2 sends a request through its communication unit through the network 8 to the communications unit of the central database 1 for any information contained in patient's medical history at 14. The processing unit of the central database 1 then obtains the patient's medical history from its memory storage unit. If the memory storage device contains the patient's medical history, then said medical history is sent through the communications unit of the central database through the network 8 to the communications device of the doctor component 2. If the memory storage device does not contain the patient's medical history, then data is sent to the doctor component 2 in the same manner indicating that no medical history was found. Once the doctor component 2 receives the patient's medical history or data indicating there is no patient medical history available at 15, the processing unit of the doctor component 2 compares all data available from the central database 1, the local database 3, and the memory unit of the card 7. The most recent version of the patient's medical history is then loaded to the local database 3, the memory unit of the patient component 7 through the port 5, and sent to the central database 1 through the communications unit and the network 8.

The doctor then prescribes a medication and enters the necessary prescription data into the doctor component 2 at 16. The patient then gives the patient component 6 and the security data to the doctor again at 17. The security data are compared for a match at 18 in the same or similar manner as 12. If there is a match, the processing unit of the doctor component 2 updates the local database 3, the memory unit 7 of the patient component 6 through the port 5, and the central database 1 through the communications unit and the network 8 with the most recent version which includes the prescription data at 19. In an alternate embodiment, the doctor component 2 retains the security data so that the patient need only give the security data once. The interface may also be maintained so that the patient will only have to interface the patient component 6 once. The patient component 6 is then returned to the patient at 19. The system can also be altered so that the security data comparisons at 12 and 18 are combined for efficiency reasons.

Additionally, when the doctor enters a new prescription, the processing unit of the doctor component 2 compares the new prescription and the list of prescriptions in the patient's medical history and displays a warning through the display if any of the medications being taken by the patient will interact causing unwanted side effects. The processing unit can accomplish this by checking the combination of newly and previously prescribed drugs against a database representing drug combinations with undesirable side effects. In one embodiment, where the doctor component 2 is a personal computer with a display, the display can list the potential side effects. A warning may also be given if the patient has received multiple prescriptions for the same medication in a short period of time. One of ordinary skill in the art would understand a short period of time to relate to the refill period for a particular medication. A warning can issue in the case of a patient seeking early refills. This period could be set to a percentage of the refill time. For example, a warning may be issued if less than half the refill period has passed since the previous prescription was filled for a particular medication. Where the doctor component 2 comprises a computer with a display, the warning could consist of a screen notifying the doctor a prescription is an early refill. The warning may be an audible or visual alarm. Depending on the nature of the medication sought and any extenuating circumstances, the doctor can then make an informed decision about refilling the prescription. In one embodiment, the processor of the doctor component 2 analyzes the patients' medical history presented on the patient component 6 for trends that would indicate patient abuse or prescription shopping. Upon determination of such a trend, the doctor component 2 issues a warning. The doctor will then be alerted to the fact that the patient may have a drug problem or may be reselling the medication. If a warning is given, the doctor has the option of canceling the prescription. In an alternate embodiment, the doctor component only communicates with the central database once instead of at 14 and 19. This is not preferred because the appropriate medication warnings may not be available without the data from the central database.

Also, if the central database 1 is unavailable due to network or other malfunction the doctor component 2 reacts as if no medical history was present on the central database 1. Otherwise, the transaction is carried out as previously described. The prescription data can be loaded from the patient component 6 and the prescription filled. The local database 3 of the doctor component 2 and the local database 3 of the pharmacist component 4 store prescription data so that the central database 1 may be automatically updated when the network 8 is repaired. Additionally, the central database 1 will be updated the next time the patient uses the patient component 6 in the same fashion as at 14.

The patient then proceeds to the pharmacy and interfaces data transfer unit 9 of the patient component 6 with the port 5 of the pharmacist component 4 and enters the security data at 20. The patient or pharmacist personnel can perform this process in the same or similar manner as the interface at the doctor's office at 11. The processing unit of the pharmacist component compares the security data at 21 in the same or similar manner as at 12. If the security data match, the pharmacist component 4 obtains the patient's medical history from the central database 1 through the network 8 at 22 in the same or similar manner as the doctor component 2 does at 14. The processing unit of the pharmacist component 4 then compares the available medical history versions and updates the local database 3, central database 1, and the memory unit 7 of the patient component 6 with the most recent version at 23 in the same or similar manner as 14. The pharmacist component 4 also returns any warnings based on drug interactions or repeated prescriptions in the same or similar manner as the doctor component 2 at 19.

The pharmacist then proceeds to fill the prescription at 24 by using standard pharmacy procedure. A patient may have more than one prescription, in which case the pharmacy must select which prescription to fill. At 25, the patient component 6 is once again interfaced with the pharmacist component 4 and the security data is entered in the same or similar manner as at 11. The security data is once again compared at 25 in the same or similar manner as at 12. If the security data matches, the patient's medical history is updated to indicate that the prescription has been filled and picked up. The new medical history is then loaded to the local database 3, central database 1, and the memory unit 7 of the patient component at 27 in the same or similar manner as 19. The patient is then allowed to leave with the medication at 28. If the central database 1 is unavailable during this process due to network or other malfunction, the pharmacist component 4 reacts as if no medical history was stored on the central database 1. The central database 1 may then be updated automatically when the network 8 is repaired.

In another embodiment, the pharmacist component 4 retains the security data of the patient component 6 so that the security data need only be entered once at 20. The patient component 6 is then returned with the medication at 28. This embodiment is not preferred because an unauthorized user may attempt to obtain the prescription. The better system requires the security data be entered again when the medication is picked up to ensure that the person receiving the prescription is the same person who requested the prescription at 20.

In an alternate embodiment, if a prescription is filled at a new pharmacy (for example from another pharmacist component 4), the central database 1 sends an updated medical history to the last pharmacy used indicating that the prescription has been filled elsewhere. In this way the local databases 3 of both the old and new pharmacies have been updated and the prescription has effectively been transferred from an old pharmacy to a new pharmacy. This process occurs automatically when the central database 1 receives the updated patient medical history indicating the fill at 25 from a new pharmacy. This would increase network traffic, but would help prevent patients from obtaining twice the prescribed medication. Additionally, this system of repeated updates depicted in FIG. 2 is advantageous because this system allows practitioners at each step to prevent the patient from obtaining prescriptions for the same medications from multiple doctors or filling the same prescription multiple times.

In another scenario, where the patient already has his patient component 6 loaded with his medical history and security data, the patient may want to obtain a medication from a doctor but be unable to go to the doctor's office. In this case, the patient contacts the doctor by telephone or other means and requests a medication at 29. The doctor inputs the patient's information into the doctor component 2 at 30 by using the alpha numeric keyboard 54 or similar input device. The doctor component 2 then retrieves the patient's medical history from the central database 1 through the network 8 at 31 in the same or similar manner as 14. The processing unit of the doctor component 2 then compares the medical history from the central database with the medical history stored on the local database and updates each with the most recent version at 32 in the same or similar manner as 15. The doctor prescribes the medication on the doctor component 2 at 33. The doctor component 2 then updates the local database 3 and the central database 1 with the most recent medical history, which includes the new prescription at 34 in the same or, similar manner as 32. In an alternate embodiment, 31 and 34 are combined for efficiency reasons. In that case, step 31 is omitted and the doctor makes the prescription without the benefit of any information stored on the central database.

The patient then proceeds to the pharmacy and interfaces the patient component 6 with the pharmacist component 4 at 20. The prescription is then filled in the same or similar manner as previously indicated. When the pharmacist component 4 compares the medical history from the central database 1, local database 3, and the memory unit 7 of the patient component 6 at 23 the version contained on the central database 1 is the most recent. The new medical history containing the prescription data is then updated to all three locations; and, the prescription process continues as previously discussed.

In an additional scenario, the patient has limited time, wants the medication available at the pharmacy when he arrives, and already has an unfilled prescription stored in his medical history. The patient contacts the pharmacist by telephone or other similar means to request the medication at 35. The pharmacist inputs the patient's information into the pharmacist component 4 at 36 by use of the alphanumeric keyboard 54. The pharmacist component 4 then contacts the central database in the same or similar manner as at 14 and retrieves the patient's medical history at 37. The processing unit of the pharmacist component 4 then compares the medical history on the local database 3 with the medical history from the central database 1 and updates both with the most recent version at 38 in the same or similar manner as 34. If the patient has an outstanding prescription stored at the pharmacy or on the central database 1, the prescription is filled at 24 as normal. The prescription process then proceeds in the same or similar manner as previously disclosed. When the patient gives the proper security data, the memory 7 unit of the patient component 6, the local database 3 of the pharmacist component 4, and the central database 1 are updated to indicate that the prescription has been filled and picked up at 25. In an alternate embodiment, the central database 1 is not contacted at 37 if the prescription is available on the medical history saved in the pharmacist's local database 3. This is not preferred, however, because the central database 1 may contain additional relevant data such as the fact that the prescription has already been filled.

In an alternative embodiment, the present invention can be incorporated into a virtual pharmacy. In a virtual pharmacy a patient undergoes examination remotely. The patient may be located at his or her home or at another location such as a satellite office or hospital. The patient's location would require internet or intranet or a network connection in order to communicate with the doctor. The remote location may also contain medical equipment, specifically instruments for making diagnostic measurements. The doctor and patient are linked via a video or teleconference where the doctor can make an inspection of the patient as well as engage the patient in questions. Additionally, the medical equipment can be configured to transmit signals representing biological measurements to the doctor's location. This provides additional information the doctor can use to make his or her diagnosis. Once the diagnosis is made, if a prescription is appropriate, the doctor enters the prescription data at the doctor component 2. The prescription data is then transferred over the network 8 or through the internet or intranet to the patients' location. A station or computer located with the patient then acts as the doctor component 2 and writes the prescription data to the patient component 6.

In another aspect, the prescription can be filled remotely. The patient can connect via internet, intranet or a network remotely to the pharmacist component 4 of the pharmacy where the prescription is to be filled. This could be done from a computer located at the patient's home or from any other system configured to read the patient component 6. The patient component 6 then interfaces the pharmacist component 4 via this connection so the pharmacist component 4 can read the prescription data contained on the patient component 6. In one embodiment, the patient must enter security data at the patient's location. Once the security data is verified, the patient component 6 is updated with the most up-to-date information. The most up-to-date information may be located on either patient component 6 or the central database 1. The patient will then be able to choose what prescription they want to fill or refill. In one embodiment, the patient may have access to online tools relating to their prescriptions or choices in medications. From there the prescription/prescriptions is/are sent to the pharmacy in the same manner as if the patient interfaced the patient component at the pharmacy. At this point the pharmacy fills any prescriptions using their standard filling procedures. The patient can then pick up the medication using the card previously discussed or the prescription can even be sent to the patient.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A paperless medication prescription system comprising:
a patient memory medium,
a doctor processor,
a pharmacist processor,
a central database,
wherein the doctor processor communicates prescription data to the patient memory medium for a prescription, and the patient memory medium communicates said prescription data to the pharmacist processor, and the pharmacist updates said prescription data on the patient memory medium when said prescription has been filled, and prescription data is stored on the central database.

2. The paperless medication prescription system of claim 1, wherein the pharmacist processor and/or the doctor processor further comprises one or more local databases, remote from said central database, for storing data read from or written to the patient memory medium.

3. The paperless medication prescription system of claim 2, wherein data from a local database of the pharmacy processor and/or data from a local database of the doctor processor or data stored on the patient memory medium updates the central database.

4. The paperless medication prescription system of claim 2, wherein the local database of the doctor processor and/or the local database of the pharmacist processor is updated with data contained on the patient memory medium.

5. The paperless medication prescription system of claim 1, wherein the doctor processor writes prescription data to the patient memory medium, wherein the pharmacist processor reads the prescription data from the patient memory medium, and the pharmacist processor writes data to the patient memory medium indicating a prescription has been filled.

6. The paperless medication prescription system of claim 1, wherein the patient memory medium remotely communicates the prescription data to the pharmacist processor and/or the doctor processor remotely communicates prescription data to the patient memory medium.

7. The paperless medication prescription system of claim 6, wherein remote communication is achieved through a network, an internet connection, or an intranet connection.

8. The paperless medication prescription system of claim 1, wherein the patient memory medium includes medical history data stored thereon.

9. The paperless medication prescription system of claim 8, wherein the pharmacist processor compares the medical history data to a current prescription being read by the pharmacist processor and/or the last prescription written to the patient memory medium by the doctor processor and warns of possible drug interactions.

10. The paperless medication prescription system of claim 1, wherein the patient memory medium includes security data stored thereon.

11. The paperless medication prescription system of claim 10, wherein said security data must be verified before the pharmacy processor and/or the doctor processor can read or write prescription data on the patient memory medium.

12. The paperless medication prescription system of claim 11, wherein the paperless prescription system further comprises an emergency override for overriding the security data.

13. The paperless medication prescription system of claim 1, wherein the doctor processor and/or the pharmacist processor generates a warning when the prescription data indicates multiple prescriptions have been granted for the same prescription.

14. A method for filling a medical prescription comprising:
interfacing a doctor processor with a patient memory medium, wherein the doctor processor stores a prescription date on the patient memory medium;
interfacing the patient memory medium and a pharmacist processor, wherein the pharmacist processor reads said prescription data from the patient memory medium and updates said prescription data on the patient memory medium when a prescription has been filled; and
storing said prescription data on a central database, wherein the pharmacy processor or the doctor processor updates the central database through a network.

15. The method of claim 14, wherein security data is entered in order to read and/or write to the patient memory medium.

16. The method of claim 14, wherein the step of interfacing the patient memory medium and the pharmacist processor further comprises the pharmacist processor writing data to the patient memory medium indicating a prescription has been filled.

17. The method of claim 14, wherein medical history data is stored on the patient memory medium.

18. The method of claim 14, wherein the pharmacist processor or doctor processor compares the patient's medical history data to the prescription data and warns of possible drug interactions.

19. The method of claim 14, wherein the doctor processor and/or the pharmacist processor generates a warning if multiple prescriptions have been granted for the same ailment in a short period of time.

20. The method of claim 14, wherein either the doctor processor remotely interfaces with the patient memory medium and/or patient memory medium remotely interfaces with the pharmacist processor.

21. The method of claim 20, wherein remote communication is achieved through a network, an internet connection, or an intranet connection, or combinations thereof.
